(19) United States
(12) Patent Application Publication
(10) Pub. No.: US 2026/0054182 A1
(43) Pub. Date: Feb. 26, 2026

(54) INFORMATION PROCESSING SYSTEM, INFORMATION PROCESSING PROGRAM, AND INFORMATION PROCESSING METHOD

(71) Applicant: SONY GROUP CORPORATION, Tokyo (JP)

(72) Inventor: Tetsugoro IHARA, Tokyo (JP)

(21) Appl. No.: 18/997,521

(22) PCT Filed: Jul. 21, 2023
(86) PCT No.: PCT/JP2023/026750

§ 371 Date: Jan. 22, 2025

(30) Foreign Application Priority Data
Aug. 3, 2022 (JP) 2022-124249

(51) Int. Cl. A63F 13/803; A63F 13/245; A63F 13/45; G06Q 30/0207

(52) U.S. Cl. CPC A63F 13/803; A63F 13/245; A63F 13/45; G06Q 30/0209

(57) ABSTRACT

An information processing system includes a processing unit that manages a mission in a real space achieved using a vehicle and play in a virtual space in association with each other.

### FIELD

The present disclosure relates to an information processing system, an information processing program, and an information processing method.

### BACKGROUND

For example, Patent Literature 1 and Patent Literature 2 propose a content presentation technologies using a vehicle.

### CITATION LIST

### Patent Literature

Patent Literature 1: JP 2021-151504 A

Patent Literature 2: JP 6102117 B2

### SUMMARY

### Technical Problem

Vehicles that are constantly connected to a network are becoming widespread. In recent years, a technology for providing a virtual space is also becoming widespread. There is room for considering an unprecedented new service.

One aspect of the present disclosure provides a new service.

### Solution to Problem

An information processing system according to one aspect of the present disclosure includes a processing unit that manages a mission in a real space achieved using a vehicle and play in a virtual space in association with each other.

An information processing program accorrding to one aspect of the present disclosure causes a computer to execute processing of managing a mission in a real space achieved using a vehicle and play in a virtual space in association with each other.

An information processing method according to one aspect of the present disclosure includes managing a mission in a real space achieved using a vehicle and play in a virtual space in association with each other.

### BRIEF DESCRIPTION OF DRAWINGS

FIG. 1 is a diagram illustrating an example of a schematic configuration of a vehicle 1.

FIG. 2 is a diagram illustrating an example of a sensing area of a camera 51, a radar 52, a LiDAR 53, an ultrasonic sensor 54, and the like of an outside recognition sensor 25.

FIG. 3 is a diagram illustrating an example of a schematic configuration of an information processing system 200 according to an embodiment.

FIG. 4 is a diagram illustrating an example of a mission DB 932.

FIG. 5 is a diagram illustrating an example of mission contents.

FIG. 6 is a diagram schematically illustrating an example of a mission content.

FIG. 7 is a diagram schematically illustrating an example of a mission content.

FIG. 8 is a diagram schematically illustrating an example of a mission content.

FIG. 9 is a diagram schematically illustrating an example of a mission content.

FIG. 10 is a diagram schematically illustrating an example of a mission content.

FIG. 11 is a diagram schematically illustrating an example of a mission content.

FIG. 12 is a diagram schematically illustrating an example of a mission content.

FIG. 13 is a diagram schematically illustrating an example of a mission content.

FIG. 14 is a diagram illustrating an example of a play DB 933.

FIG. 15 is a diagram illustrating an example of an incentive.

FIG. 16 is a diagram schematically illustrating an example of the incentive.

FIG. 17 is a diagram schematically illustrating an example of the incentive.

FIG. 18 is a diagram schematically illustrating an example of the incentive.

FIG. 19 is a diagram schematically illustrating an example of the incentive.

FIG. 20 is a diagram schematically illustrating an example of the incentive.

FIG. 21 is a diagram schematically illustrating an example of the incentive.

FIG. 22 is a diagram illustrating an example of a reward.

FIG. 23 is a diagram schematically illustrating an example of reward provision.

FIG. 24 is a diagram schematically illustrating an example of reward provision.

FIG. 25 is a diagram schematically illustrating an example of reward provision.

FIG. 26 is a diagram schematically illustrating an example of reward provision.

FIG. 27 is a diagram schematically illustrating an example of reward provision.

FIG. 28 is a diagram schematically illustrating an example of a display area of a visual reward.

FIG. 29 is a diagram schematically illustrating an example of a display area of a visual reward.

FIG. 30 is a diagram schematically illustrating an example of a display area of a visual reward.

FIG. 31 is a diagram schematically illustrating an example of a display area of a visual reward.

FIG. 32 is a diagram schematically illustrating an example of a display area of a visual reward.

FIG. 33 is a diagram schematically illustrating an example of a display area of a visual reward.

FIG. 34 is a diagram schematically illustrating an example of a display area of a visual reward.

FIG. 35 is a diagram illustrating an example of a reward distribution DB 934.

FIG. 36 is a flowchart illustrating an example of processing (information processing method) executed in the information processing system 200.

FIG. 37 is a diagram illustrating an example of a hardware configuration of a device.

### DESCRIPTION OF EMBODIMENTS

Hereinafter, an embodiment of the present disclosure will be described in detail with reference to the drawings. Note that in the following embodiment, the same elements are denoted by the same reference numerals, and redundant description will be omitted.

The present disclosure will be described according to the following order of items.
0. Introduction
1. Example of vehicle configuration
2. Embodiment
3. Modification
4. Example of hardware configuration
5. Example effects

### 0. Introduction

Patent Literature 1 discloses a technology for providing a game program that can display a game image by replacing another vehicle in a real landscape by recognizing vehicle information of the other vehicle from image data captured by an imaging unit in an automatic driving vehicle or the like and drawing the game image corresponding to the recognized vehicle information, and can enhance realistic feeling. In addition, Patent Literature 2 discloses a technology for reproducing a spatial sense of realism in a specific place and providing an immersive feeling in an immersive car on the basis of environmental information acquired by a sensor group arranged in the specific place.

With the improvement in technology, vehicles that are constantly connected to a network are increasing. In addition, a technology for providing a virtual space is also becoming widespread. According to the disclosed technology, it is possible to provide an unprecedented new service.

### 1. Example of Vehicle Configuration

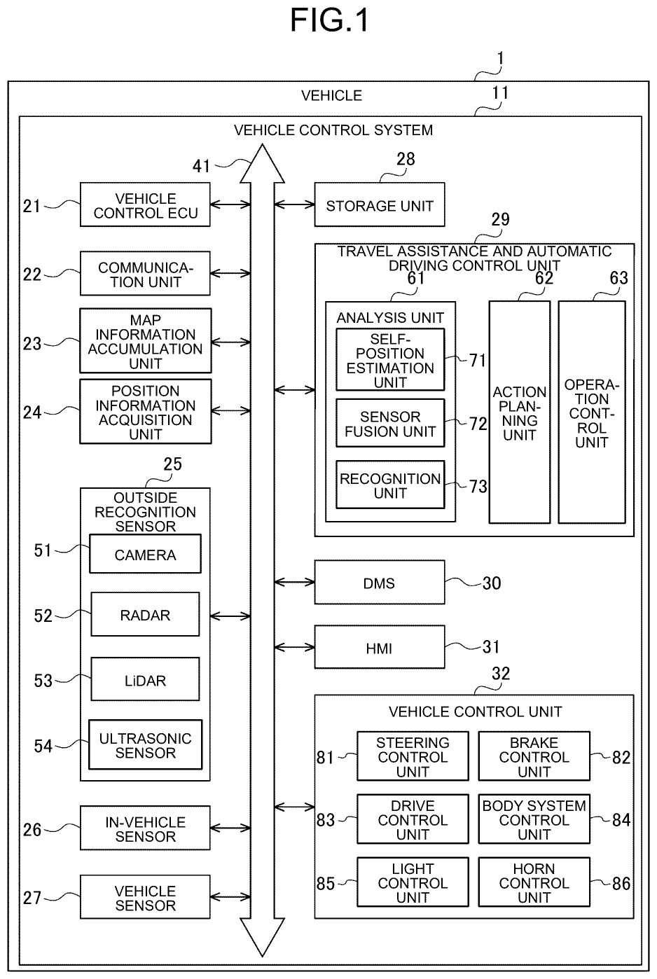

FIG. 1 is a diagram illustrating an example of a schematic configuration of a vehicle 1. A vehicle control system 11 is mounted on the vehicle 1 and controls the vehicle 1. The vehicle control system 11 includes a vehicle control electronic control unit (ECU) 21, a communication unit 22, a map information accumulation unit 23, a position information acquisition unit 24, an outside recognition sensor 25, an in-vehicle sensor 26, a vehicle sensor 27, a storage unit 28, a travel assistance and automatic driving control unit 29, a driver monitoring system (DMS) 30, a human machine interface (HMI) 31, and a vehicle control unit 32. These parts are communicably connected to each other via a communication network 41.

The communication network 41 includes, for example, an in-vehicle communication network, a bus, or the like conforming to a digital bidirectional communication standard such as a controller area network (CAN), a local interconnect network (LIN), a local area network (LAN), FlexRay (registered trademark), or Ethernet (registered trademark). The communication network 41 may be selectively used depending on the type of data to be transmitted. For example, CAN may be applied to data related to vehicle control, and Ethernet may be applied to large-capacity data.

Note that each unit of the vehicle control system 11 may be directly connected not via the communication network 41 but by using wireless communication that assumes communication at a relatively short distance, such as near field communication (NFC) or Bluetooth (registered trademark).

The vehicle control ECU 21 includes, for example, various processors such as a central processing unit (CPU) and a micro processing unit (MPU). The vehicle control ECU 21 controls the entire vehicle control system 11 and controls some functions of the vehicle control system 11.

The communication unit 22 communicates with various devices inside and outside the vehicle, other vehicles, servers, base stations, and the like, and transmits and receives various data. The communication unit 22 may perform communication using a plurality of communication methods.

Some examples of communication with the outside of the vehicle by the communication unit 22 will be described. The communication unit 22 may communicate with a server (hereinafter also referred to as external server) or the like existing on an external network via a base station or an access point by a wireless communication method such as 5th generation mobile communication system (5G), long term evolution (LTE), or dedicated short range communications (DSRC). Examples of the external network include the Internet, a cloud network, and a company-specific network. The communication method is not particularly limited, and may be, for example, a wireless communication method capable of performing digital bidirectional communication at a predetermined communication speed or more and a predetermined distance or more.

The communication unit 22 may communicate with a terminal in the vicinity of the own vehicle using a peer to peer (P2P) technology. Examples of such a terminal include a terminal worn by a moving body that moves at a relatively low speed such as a pedestrian or a bicycle, a terminal installed in a store or the like in a fixed position, a machine type communication (MTC) terminal, and the like. The communication unit 22 may perform V2X communication. Examples of the V2X communication include vehicle-to-vehicle communication with another vehicle, vehicle-to-infrastructure communication with a roadside device or the like, vehicle-to-home communication, vehicle-to-pedestrian communication with a terminal or the like possessed by a pedestrian, and the like.

The communication unit 22 may receive a program for updating software for controlling the operation of the vehicle control system 11 from the outside (over the air). The communication unit 22 may receive map information, traffic information, information around the vehicle 1, and the like from the outside.

The communication unit 22 may transmit information regarding the vehicle 1, information around the vehicle 1, and the like to the outside. Examples of the information to be transmitted include data indicating the state of the vehicle 1, a recognition result by a recognition unit 73 described later, and the like. The communication unit 22 may perform communication corresponding to a vehicle emergency call system such as e-call.

The communication unit 22 may receive electromagnetic waves transmitted by a road traffic information communication system (VICS: vehicle information and communication system(registered trademark)) such as a radio wave beacon, an optical beacon, or FM multiplex broadcasting.

Some examples of communication with the inside of the vehicle by the communication unit 22 will be described. The communication unit 22 may communicate with each device in the vehicle by using, for example, wireless communication. The wireless communication may be wireless communication by a communication method capable of performing digital bidirectional communication at a predetermined communication speed or more. Examples of such wireless communication include wireless LAN, Bluetooth, NFC, wireless USB (WUSB), and the like.

The communication unit 22 may communicate with each device in the vehicle by wired communication via a cable connected to a connection terminal (not illustrated). The wired communication may be wired communication by a communication method capable of performing digital bidirectional communication at a predetermined communication speed or more. Examples of such wired communication include universal serial bus (USB), high-definition multimedia interface (HDMI) (registered trademark), mobile high-definition link (MHL), and the like.

The in-vehicle device may be a device that is not connected to the communication network 41 in the vehicle. Examples of the device include a mobile terminal or a wearable device carried by an occupant such as the driver, an information device brought into the vehicle and temporarily installed, and the like.

The map information accumulation unit 23 accumulates at least one of a map acquired from the outside and a map created by the vehicle 1. Examples of the accumulated map include a three-dimensional high-precision map, a global map that is less accurate than the high-precision map and covers a wide area, and the like.

Examples of the high-precision map include a dynamic map, a point cloud map, a vector map, and the like. The dynamic map is, for example, a map including four layers of dynamic information, semi-dynamic information, semi-static information, and static information, and is provided to the vehicle 1 from an external server or the like. The point cloud map is a map including a point cloud (point cloud data). The vector map is, for example, a map in which traffic information such as a lane and a position of a traffic light is associated with a point cloud map and adapted to an advanced driver assistance system (ADAS) or autonomous driving (AD).

The point cloud map and the vector map may be provided from an external server or the like, or may be created by the vehicle 1 as a map for performing matching with a local map described later on the basis of a result of sensing by a camera 51, a radar 52, a LiDAR 53, or the like, and may be accumulated in the map information accumulation unit 23. In a case where a high-precision map is provided from an external server or the like, for example, map data of several hundred meters square regarding a planned route on which the vehicle 1 travels from now is acquired from an external server or the like in order to reduce the communication capacity.

The position information acquisition unit 24 functions as a position sensor or the like that receives a global navigation satellite system (GNSS) signal from a GNSS satellite and acquires position information of the vehicle 1. The acquired position information is supplied to the travel assistance and automatic driving control unit 29. Note that the position information may be acquired using a method other than the method using the GNSS signal, such as a beacon.

The outside recognition sensor 25 includes various sensors used for recognizing the situation outside the vehicle 1, and supplies sensor data from each sensor to each unit of the vehicle control system 11. The type and number of sensors included in the outside recognition sensor 25 are arbitrary.

In this example, the outside recognition sensor 25 includes the camera 51, the radar 52, the light detection and ranging or laser imaging detection and ranging (LiDAR) 53, and an ultrasonic sensor 54. A sensor other than the exemplified sensors may be included in the outside recognition sensor 25. The sensing area of each sensor will be described later.

The imaging method of the camera 51 is not particularly limited. For example, cameras of various imaging methods such as a time of flight (ToF) camera, a stereo camera, a monocular camera, and an infrared camera, which are imaging methods capable of distance measurement, are used as the camera 51 as necessary. Note that the camera 51 may be a camera for simply acquiring a captured image regardless of distance measurement.

The outside recognition sensor 25 may include an environment sensor for detecting an environment for the vehicle 1. The environment sensor detects an environment such as the weather and brightness. Examples of the environmental sensor include a raindrop sensor, a fog sensor, a sunshine sensor, a snow sensor, and an illuminance sensor.

The outside recognition sensor 25 may include a microphone used for detecting sound around the vehicle 1, a position of a sound source, and the like.

The in-vehicle sensor 26 detects in-vehicle information. Sensor data of the in-vehicle sensor 26 is supplied to each unit of the vehicle control system 11. Examples of the in-vehicle sensor 26 include a camera, a radar, a seating sensor, a steering wheel sensor, a microphone, a biological sensor, and the like. Examples of the camera include cameras of various imaging methods capable of measuring a distance, such as a ToF camera, a stereo camera, a monocular camera, and an infrared camera. The camera may be a camera for simply acquiring a captured image regardless of distance measurement. The biological sensor is provided, for example, on a seat, a steering wheel, or the like, and detects various types of biological information of an occupant such as the driver.

The vehicle sensor 27 detects the state of the vehicle 1. Sensor data of the vehicle sensor 27 is supplied to each unit of the vehicle control system 11. For example, the vehicle sensor 27 may include a speed sensor, an acceleration sensor, an angular velocity sensor (gyro sensor), an inertial measurement unit (IMU) integrating these sensors, and the like. The vehicle sensor 27 may include a steering angle sensor that detects a steering angle of a steering wheel, a yaw rate sensor, an accelerator sensor that detects an operation amount of an accelerator pedal, a brake sensor that detects an operation amount of a brake pedal, and the like. The vehicle sensor 27 may include a rotation sensor that detects the rotation speed of an engine or a motor, an air pressure sensor that detects the air pressure of a tire, a slip rate sensor that detects the slip rate of a tire, a wheel speed sensor that detects the rotation speed of a wheel, and the like. The vehicle sensor 27 may include a battery sensor that detects a remaining amount and a temperature of a battery, an impact sensor that detects an external impact, and the like.

The storage unit 28 includes at least one of a nonvolatile storage medium and a volatile storage medium, and stores data and a program. The storage unit 28 is used as, for example, an electrically erasable programmable read-only memory (EEPROM), a random access memory (RAM), or the like. Examples of the storage medium include a magnetic storage device such as a hard disc drive (HDD), a semiconductor storage device, an optical storage device, a magneto-optical storage device, and the like. The storage unit 28 stores various programs and data used by each unit of the vehicle control system 11. For example, the storage unit 28 has a function of an event data recorder (EDR) or a data storage system for automated driving (DSSAD), and stores information of the vehicle 1 before and after an event such as an accident or information acquired by the in-vehicle sensor 26.

The travel assistance and automatic driving control unit 29 controls travel assistance and automatic driving of the vehicle 1. In this example, the travel assistance and automatic driving control unit 29 includes an analysis unit 61, an action planning unit 62, and an operation control unit 63.

The analysis unit 61 analyzes the situation of the vehicle 1 and the surroundings. In this example, the analysis unit 61 includes a self-position estimation unit 71, a sensor fusion unit 72, and the recognition unit 73.

The self-position estimation unit 71 estimates the self-position of the vehicle 1 on the basis of sensor data from the outside recognition sensor 25 and a high-precision map accumulated in the map information accumulation unit 23. For example, the self-position estimation unit 71 estimates the self-position of the vehicle 1 by generating a local map on the basis of sensor data from the outside recognition sensor 25 and matching the local map with the high-precision map. The position of the vehicle 1 is based on, for example, the center of a rear wheel pair axle.

Examples of the local map include a three-dimensional high-precision map created using a technology such as simultaneous localization and mapping (SLAM), an occupancy grid map, and the like. An example of the three-dimensional high-precision map is the point cloud map described above. The occupancy grid map is a map in which a three-dimensional or two-dimensional space around the vehicle 1 is divided into grids of a predetermined size, and an occupancy state of an object is indicated in units of grids. The occupancy state of an object is indicated by, for example, the presence or absence or existence probability of the object. The local map is also used for detection processing and recognition processing of the situation outside the vehicle 1 by the recognition unit 73, for example.

Note that the self-position estimation unit 71 may estimate the self-position of the vehicle 1 on the basis of position information acquired by the position information acquisition unit 24 and sensor data from the vehicle sensor 27.

The sensor fusion unit 72 combines a plurality of different types of sensor data (e.g., image data supplied from camera 51 and sensor data supplied from radar 52) to perform processing (sensor fusion processing) for obtaining new information. Examples of combination approaches are integration, fusion, union, and the like.

The recognition unit 73 detects the situation outside the vehicle 1 and recognizes the situation outside the vehicle 1. For example, the recognition unit 73 detects and recognizes the situation outside the vehicle 1 on the basis of information from the outside recognition sensor 25, information from the self-position estimation unit 71, information from the sensor fusion unit 72, and the like.

Specifically, for example, the recognition unit 73 detects and recognizes an object around the vehicle 1. Examples of detection of an object include detection of the presence or absence, size, shape, position, motion, and the like of the object. Examples of recognition of an object include recognition of an attribute such as the type of the object, identification of a specific object, and the like. Note that the detection processing and the recognition processing are not necessarily clearly separated, and the processing may overlap.

For example, the recognition unit 73 detects an object around the vehicle 1 by performing clustering to classify point clouds based on sensor data by the radar 52, the LiDAR 53, or the like into clusters of point clouds. As a result, the presence or absence, size, shape, and position of an object around the vehicle 1 are detected.

For example, the recognition unit 73 detects the motion of the object around the vehicle 1 by performing tracking of following the motion of clusters of point clouds classified by clustering. As a result, the speed and the traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, and the like on the basis of image data supplied from the camera 51. The recognition unit 73 may recognize the type of the object around the vehicle 1 by performing recognition processing such as semantic segmentation.

For example, the recognition unit 73 recognizes the traffic rule around the vehicle 1 on the basis of maps accumulated in the map information accumulation unit 23, the estimation result of the self-position by the self-position estimation unit 71, and the recognition result of objects around the vehicle 1 by the recognition unit 73. As a result, the position and the state of a traffic light, contents of a traffic sign and a road sign, contents of traffic regulation, travelable lanes, and the like are recognized.

For example, the recognition unit 73 recognizes the surrounding environment of the vehicle 1. Examples of the surrounding environment include weather, temperature, humidity, brightness, a state of a road surface, and the like.

The action planning unit 62 creates an action plan of the vehicle 1. For example, the action planning unit 62 creates an action plan by performing processing of route planning and route following. Route planning (global path planning) is planning of a rough route from the start to the goal. Route planning is called track planning, and may include generation of a track (local path planning) in the vicinity of the vehicle 1 that can be safely and smoothly traveled in consideration of the motion characteristics of the vehicle 1 in the planned route.

Route following is planning an operation for safely and accurately traveling a route planned by route planning within a planned time. For example, the action planning unit 62 calculates a target speed and a target angular velocity of the vehicle 1 on the basis of a result of route following.

The operation control unit 63 controls the operation of the vehicle 1 in order to carry out the action plan created by the action planning unit 62. For example, the operation control unit 63 controls a steering control unit 81, a brake control unit 82, and a drive control unit 83 of the vehicle control unit 32 described later, and performs acceleration and deceleration control and direction control such that the vehicle 1 travels on the track calculated by the track planning. The operation control unit 63 may perform cooperative control for the purpose of implementing functions of the ADAS such as collision avoidance or impact mitigation, follow-up traveling, vehicle speed maintaining traveling, collision warning of the own vehicle, lane deviation warning of the own vehicle, and the like. The operation control unit 63 may perform cooperative control for the purpose of automatic driving or the like in which the vehicle autonomously travels without depending on the operation of the driver.

The DMS 30 authenticates the driver and recognizes the state of the driver on the basis of sensor data from the in-vehicle sensor 26, input data input to the HMI 31 described later, and the like. Examples of the state of the driver include a physical condition, a wakefulness level, a concentration level, a fatigue level, a line-of-sight direction, a drunkenness level, a driving operation, and a posture.

The DMS 30 may perform authentication processing of an occupant other than the driver and recognition processing of the state of the occupant. The DMS 30 may recognize the situation inside the vehicle on the basis of sensor data from the in-vehicle sensor 26. Examples of the situation inside the vehicle include temperature, humidity, brightness, odor, and the like.

The HMI 31 inputs various data, instructions, and the like, and presents various data to the driver or the like. The HMI 31 includes an input device for a person to input data, and may also function as a sensor. The HMI 31 generates an input signal on the basis of data, an instruction, or the like input by the input device, and supplies the input signal to each unit of the vehicle control system 11. Examples of the input device include a touch panel, a button, a switch, and a lever. The input device may be an input device capable of inputting information by a method other than manual operation, by voice, gesture, or the like. An external connection device such as a remote control device using infrared rays or radio waves, or a mobile device or a wearable device corresponding to the operation of the vehicle control system 11 may be used as the input device.

The HMI 31 generates visual information, auditory information, olfactory information, and tactile information for the occupant or the outside of the vehicle. The HMI 31 controls output, an output content, an output timing, an output method, and the like of each piece of generated information. Examples of the visual information include information indicated by an image or light such as an operation screen, display of a state of the vehicle 1, a warning display, and a monitor image indicating the situation around the vehicle 1. Examples of the auditory information include information indicated by sound such as voice guidance, a warning sound, and a warning message. An example of the olfactory information is information indicated by aroma emitted from a cartridge filled with perfume. Examples of the tactile information is information given to the tactile sense of the occupant by force, vibration, motion, air blow, and the like.

Examples of the visual information output device include a display device that presents visual information by displaying an image by itself, a projector device that presents visual information by projecting an image, and the like. The display device may be a device that displays visual information in the field of view of the occupant, such as a head-up display, a transmissive display, or a wearable device having an augmented reality (AR) function, in addition to a display device having a normal display. A display device included in a navigation device, an instrument panel, a camera monitoring system (CMS), an electronic mirror, a lamp, or the like provided in the vehicle 1 may be used as the output device. A window of the vehicle 1 may be used as the output device. A road surface illuminated by a light may be used as the output device.

Examples of the device that outputs auditory information include an audio speaker, headphones, and earphones.

An example of the device that outputs tactile information is a haptics element using haptics technology. The haptics element is provided, for example, at a portion with which an occupant of the vehicle 1 comes into contact, such as a steering wheel or a seat.

The vehicle control unit 32 controls each unit of the vehicle 1. In this example, the vehicle control unit 32 includes the steering control unit 81, the brake control unit 82, the drive control unit 83, a body system control unit 84, a light control unit 85, and a horn control unit 86.

The steering control unit 81 detects and controls the state of the steering system of the vehicle 1. Examples of the steering system include a steering mechanism including a steering wheel and the like, an electric power steering, and the like. The steering control unit 81 includes, for example, a steering ECU that controls a steering system, an actuator that drives the steering system, and the like.

The brake control unit 82 detects and controls the state of the brake system of the vehicle 1. The brake system includes, for example, a brake mechanism including a brake pedal and the like, an antilock brake system (ABS), a regenerative brake mechanism, and the like. The brake control unit 82 includes, for example, a brake ECU that controls the brake system, an actuator that drives the brake system, and the like.

The drive control unit 83 detects and controls the state of a drive system of the vehicle 1. The drive system includes, for example, an accelerator pedal, a driving force generation device for generating a driving force of an internal combustion engine or a driving motor, a driving force transmission mechanism for transmitting the driving force to wheels, and the like. The drive control unit 83 includes, for example, a drive ECU that controls the drive system, an actuator that drives the drive system, and the like.

The body system control unit 84 detects and controls the state of the body system of the vehicle 1. The body system includes, for example, a keyless entry system, a smart key system, a power window device, a power seat, an air conditioner, an airbag, a seat belt, a shift lever, and the like. The body system control unit 84 includes, for example, a body system ECU that controls the body system, an actuator that drives the body system, and the like.

The light control unit 85 detects and controls states of various lights of the vehicle 1. Examples of the light include a headlight, a backlight, a fog light, a turn signal, a brake light, a projection, and a display of a bumper. The light control unit 85 includes a light ECU that controls light, an actuator that drives light, and the like.

The horn control unit 86 detects and controls the state of a car horn of the vehicle 1. The horn control unit 86 includes, for example, a horn ECU that controls the car horn, an actuator that drives the car horn, and the like.

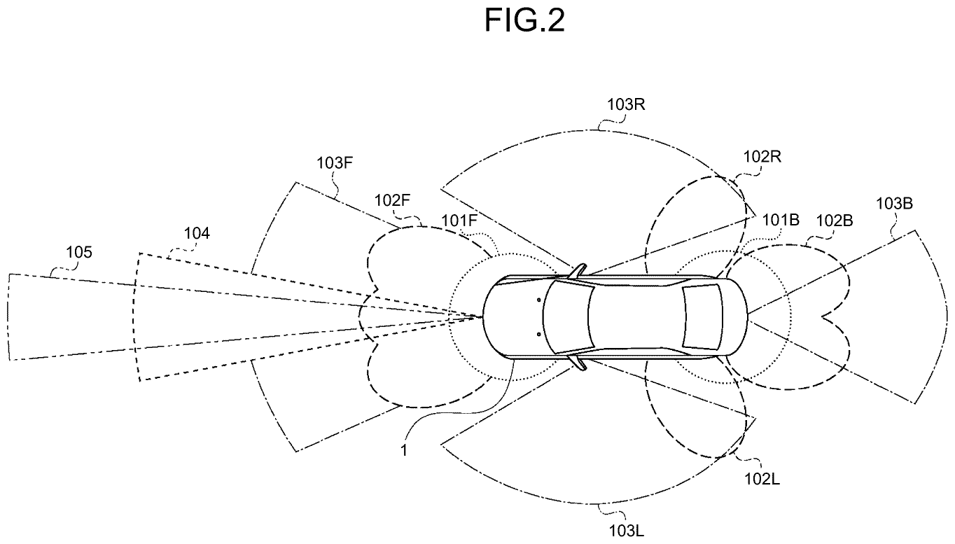

FIG. 2 is a diagram illustrating an example of the sensing area of the camera 51, the radar 52, the LiDAR 53, the ultrasonic sensor 54, and the like of the outside recognition sensor 25. Note that FIG. 2 schematically illustrates the vehicle 1 as viewed from above, where the lower end side is the front end (front) side of the vehicle 1, and the upper end side is the rear end (rear) side of the vehicle 1.

A sensing area 101F and a sensing area 101B are examples of the sensing area of the ultrasonic sensor 54. The sensing area 101F covers the periphery of the front end of the vehicle 1 by the plurality of ultrasonic sensors 54. The sensing area 101B covers the periphery of the rear end of the vehicle 1 by the plurality of ultrasonic sensors 54.

The sensing results in the sensing area 101F and the sensing area 101B are used, for example, for parking assistance of the vehicle 1.

Sensing areas 102F to 102B illustrate examples of the sensing area of the short-range or middle-range radar 52. The sensing area 102F covers positions farther than the sensing area 101F in front of the vehicle 1. The sensing area 102B covers positions farther than the sensing area 101B behind the vehicle 1. A sensing area 102L covers the rear periphery of a left side surface of the vehicle 1. A sensing area 102R covers the rear periphery of a right side surface of the vehicle 1.

The sensing result in the sensing area 102F is used, for example, to detect a vehicle, a pedestrian, or the like existing in front of the vehicle 1. The sensing result in the sensing area 102B is used, for example, for a collision prevention function or the like behind the vehicle 1. The sensing results in the sensing area 102L and the sensing area 102R are used, for example, for detecting an object in a blind spot on sides of the vehicle 1.

Sensing areas 103F to 103B illustrate examples of the sensing area of the camera 51. The sensing area 103F covers positions farther than the sensing area 102F in front of the vehicle 1. The sensing area 103B covers positions farther than the sensing area 102B behind the vehicle 1. A sensing area 103L covers the periphery of the left side surface of the vehicle 1. A sensing area 103R covers the periphery of the right side surface of the vehicle 1.

The sensing result in the sensing area 103F is used, for example, for recognition of a traffic light or a traffic sign, a lane departure prevention assist system, an automatic headlight control system, and the like. The sensing result in the sensing area 103B is used, for example, for parking assistance, a surround view system, and the like. The sensing results in the sensing area 103L and 103R are used, for example, for a surround view system or the like.

A sensing area 104 illustrates an example of the sensing area of the LiDAR 53. The sensing area 104 covers positions farther than the sensing area 103F in front of the vehicle 1. On the other hand, the sensing area 104 has a narrower range in the left-right direction than the sensing area 103F.

The sensing result in the sensing area 104 is used, for example, for detecting an object such as a surrounding vehicle.

A sensing area 105 illustrates an example of the sensing area of the long-range radar 52. The sensing area 105 covers positions farther than the sensing area 104 in front of the vehicle 1. On the other hand, the sensing area 105 has a narrower range in the left-right direction than the sensing area 104.

The sensing result in the sensing area 105 is used, for example, for adaptive cruise control (ACC), emergency braking, collision avoidance, and the like.

Note that the sensing areas of the sensors of the camera 51, the radar 52, the LiDAR 53, and the ultrasonic sensor 54 included in the outside recognition sensor 25 may have various configurations other than those in FIG. 2. For example, the ultrasonic sensor 54 may also sense the sides of the vehicle 1, and the LiDAR 53 may sense the rear of the vehicle 1. In addition, the installation positions of the sensors are not limited to the examples described above.

### 2. Embodiment

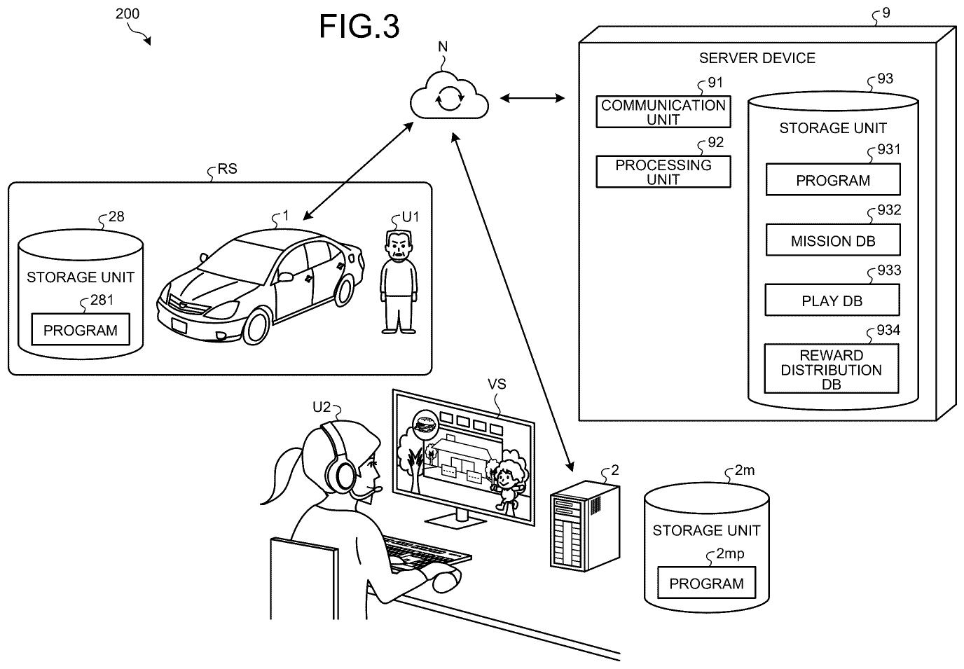

FIG. 3 is a diagram illustrating an example of a schematic configuration of an information processing system 200 according to the embodiment. The information processing system 200 includes a vehicle 1, a terminal device 2, and a server device 9.

The vehicle 1, the terminal device 2, and the server device 9 can communicate with each other via a network N. The network N to which the vehicle 1 is connected corresponds to, for example, the above-described external network. Note that data exchange between the vehicle 1 and the terminal device 2 may be performed via the server device 9, and in this case, direct communication between the vehicle 1 and the terminal device 2 is not essential.

The vehicle 1 is used in a real space RS and travels in the real space RS. A user of the vehicle 1 is referred to as a user U1 in FIG. 3. The user U1 is an occupant of the vehicle 1. The user U1 may be the driver of the vehicle 1.

A program 281 is exemplified as information stored in the storage unit 28 of the vehicle 1. The program 281 is an information processing program (application software) that causes the vehicle control system 11 to execute processing related to service provision described later.

The terminal device 2 provides a virtual space VS. Examples of the virtual space VS are metaverse, a video game space, and the like. The terminal device 2 may be an electronic device such as a PC or a dedicated game machine. A user of the terminal device 2 is referred to as a user U2 in FIG. 3. The user U2 is a user who accesses the virtual space VS and enjoys a game, an event, or the like in the virtual space VS. The user U2 may use the virtual space VS by wearing a device such as a head mount display (HMD), virtual reality (VR) goggles, or a tactile controller (not illustrated) in addition to a display device for normal video output.

A storage unit included in the terminal device 2 is referred to as a storage unit 2m in FIG. 3. A program 2mp is exemplified as information stored in the storage unit 2m. The program 2mp is an information processing program (application software) that causes the terminal device 2 to execute processing related to service provision described later.

Although details will be described later, the information processing system 200 is a system that associates an action executed by the user U1 in the real space RS by the vehicle 1 with processing in a game, an event, or the like in which the user U2 plays or participates in the virtual space VS, and fuses physical (real space) and virtual (virtual space) such that, when a task (hereinafter referred to as “mission”) in the real space RS imposed on the user U1 by the user U2 is achieved, an achievement of the task is reflected in the content (hereinafter collectively referred to as “play”) of the playing or the like in the virtual space VS. Note that although not illustrated in FIG. 3, there may be a plurality of vehicles 1 and users U1, and there may be a plurality of terminal devices 2 and users U2.

The server device 9 includes a communication unit 91, a processing unit 92, and a storage unit 93.

The communication unit 91 communicates with another device, in this example, the communication unit 22 of the vehicle control system 11 of the vehicle 1, and communicates with the terminal device 2. The processing unit 92 functions as a control unit that controls the entire server device 9 and executes various types of processing. The storage unit 93 stores information used by the server device 9. Examples of information stored in the storage unit 93 include a program 931, a mission database (DB) 932, a play DB 933, and a reward distribution DB 934. Among these, the program 931 is an information processing program that causes the server device 9 to execute processing related to service provision described later.

The processing unit 92 manages a mission in the real space RS achieved using the vehicle 1 and play in the virtual space VS in association with each other. For example, the processing unit 92 manages the mission and the play by generating and updating the mission DB 932, the play DB 933, and the reward distribution DB 934.

As will be described later, an incentive is acquired in the virtual space VS in which the user U2 of the terminal device 2 plays or a reward is provided to the user U1 of the vehicle 1 on the basis of information in each DB. For example, the vehicle 1 and the terminal device 2 may periodically access the server device 9 to acquire the information in each DB, or the server device 9 may transmit the information in each DB to the vehicle 1 and the terminal device 2 at the time of update.

Note that a part of the processing of providing the virtual space VS by the terminal device 2 may be executed by the processing unit 92 of the server device 9. In a case where the virtual space VS is a video game space or the like, it can be said that an online game using the server device 9 is provided.

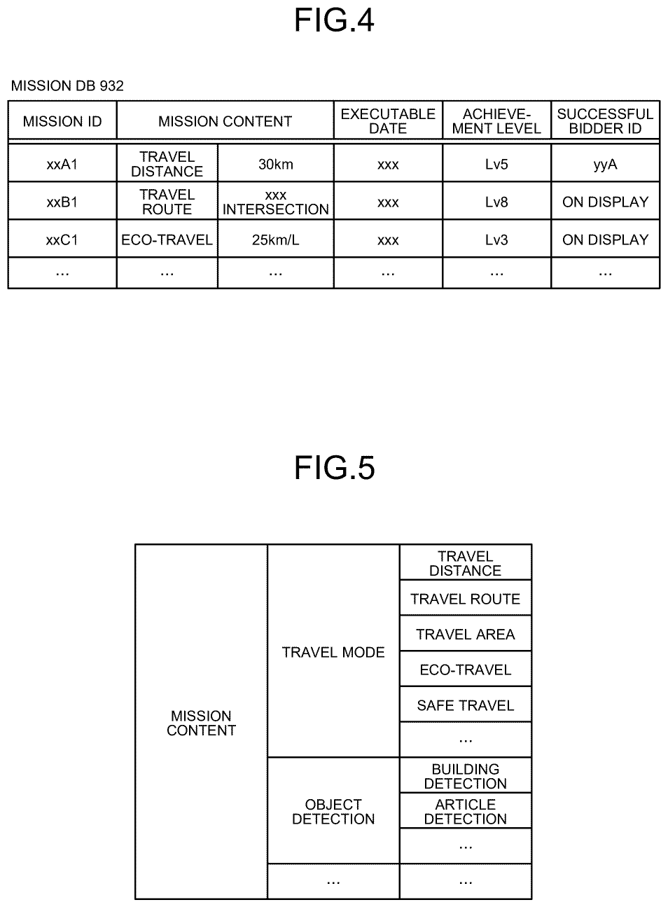

The mission DB 932 is a database in which missions in the real space RS is registered. This will be described with reference to FIG. 4.

FIG. 4 is a diagram illustrating an example of the mission DB 932. The mission DB 932 describes a mission ID, a mission content, an executable date, an achievement level, and a successful bidder ID in association with each other.

The mission ID uniquely identifies the mission and is schematically indicated as xxA1 and the like.

The mission content indicates the content of the mission. The mission contents include “travel distance: 30 km”, “travel route: xxx intersection”, and “eco-travel: 25 km/L”. “Travel distance: 30 km” indicates that the vehicle 1 travels 30 km in the real space RS. “Driving route: xxx intersection” indicates that the vehicle 1 travels so as to pass through the xxx intersection of the real space RS. “Eco-driving 25 km/L” indicates that the vehicle 1 travels in the real space RS with a low fuel consumption of about 25 km per liter of fuel.

The executable date indicates a date on which the mission can be executed. The executable date is set according to the schedule of the user U1 of the vehicle 1, for example.

The achievement level is set according to, for example, the difficulty level of the mission. For example, as the difficulty level of a mission increases, the achievement level also increases.

The various missions as described above are exhibited by the user U1 in, for example, a general matching system or an auction system (not illustrated) and registered in the mission DB 932. The successful bidder ID uniquely identifies the user U2 who won the mission, and is schematically indicated as yyA or the like. The mission whose successful bidder ID is currently on display is a mission in which a successful bid has not been made. Note that there may be a case where monetary consideration is not necessarily involved at the time of transaction between the seller and the successful bidder.

The above mission is an example, and any mission that can be achieved using the vehicle 1 can be exhibited. This will be described with reference to FIG. 5.

FIG. 5 is a diagram illustrating an example of mission contents. As the mission content, travel mode and object detection are exemplified.

Examples of travel mode include travel distance, travel route, travel area, eco-travel, and safe travel. Among these, travel distance, travel route, and eco-travel are as described above. Travel area indicates an area (place) into which the vehicle 1 enters or passes. Safe travel indicates, for example, traveling in which a margin with respect to a speed limit is set to be large or a stop period at a stop position is set to be long.

Examples of object detection include building detection and article detection. Building detection indicates that the vehicle travels to the vicinity of a specific building and detects its appearance or the like (may be signboard or the like). Examples of the building include a store, a building, a tower, a station, and a park. Article detection indicates that an appearance or the like of a specific article is detected. Examples of the article include a specialty product.

Note that detection may be understood to include, for example, analysis by the analysis unit 61 of the vehicle control system 11 of the vehicle 1, more specifically, estimation by the self-position estimation unit 71, recognition by the recognition unit 73, and the like. To the extent consistent, detection, estimation, recognition, and the like may be read as appropriate. Article detection is not limited to detection of the shape of the article itself, and may be detection via various codes (one-dimensional code, two-dimensional code, AR marker, and the like) in addition to designs and marks such as character strings, logos, patterns, and colors attached to the article itself or packaging. In addition to detection of the article itself, article detection may be combined with detection of position information, a building that is a famous place, or the like. Such object detection is performed using, for example, the outside recognition sensor 25, the in-vehicle sensor 26, and the like of the vehicle control system 11.

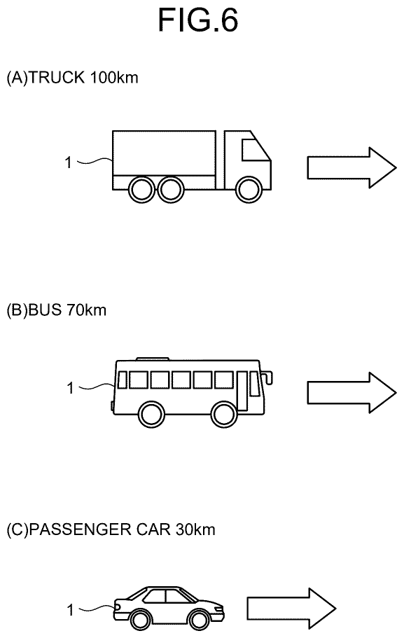

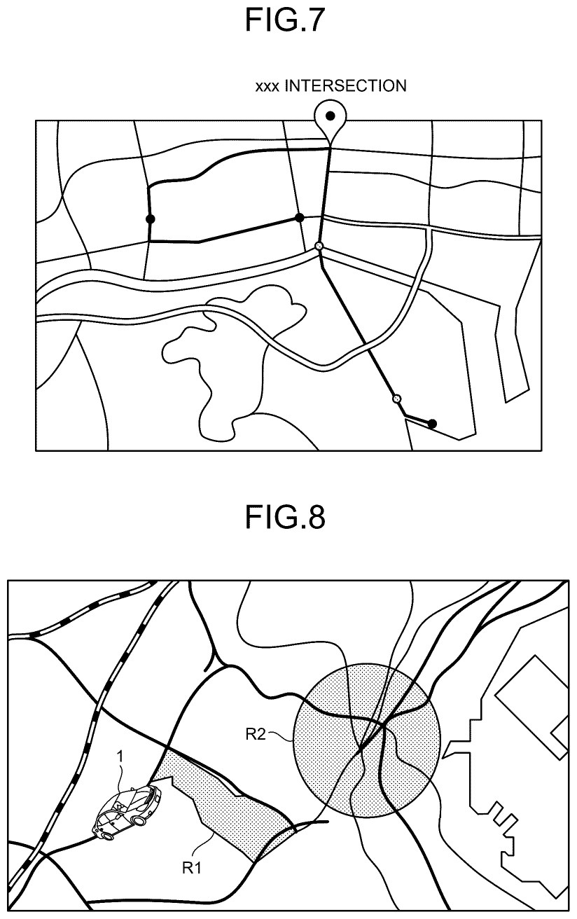

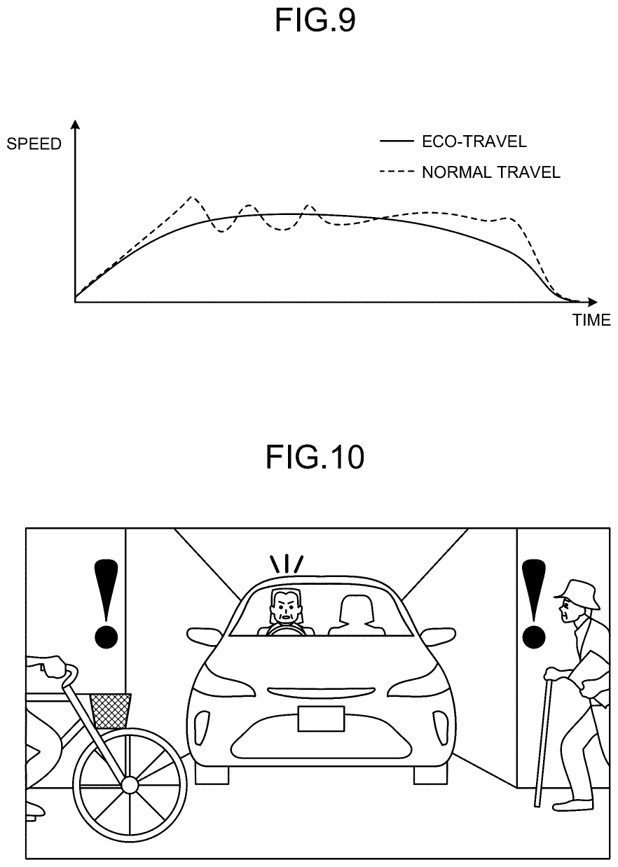

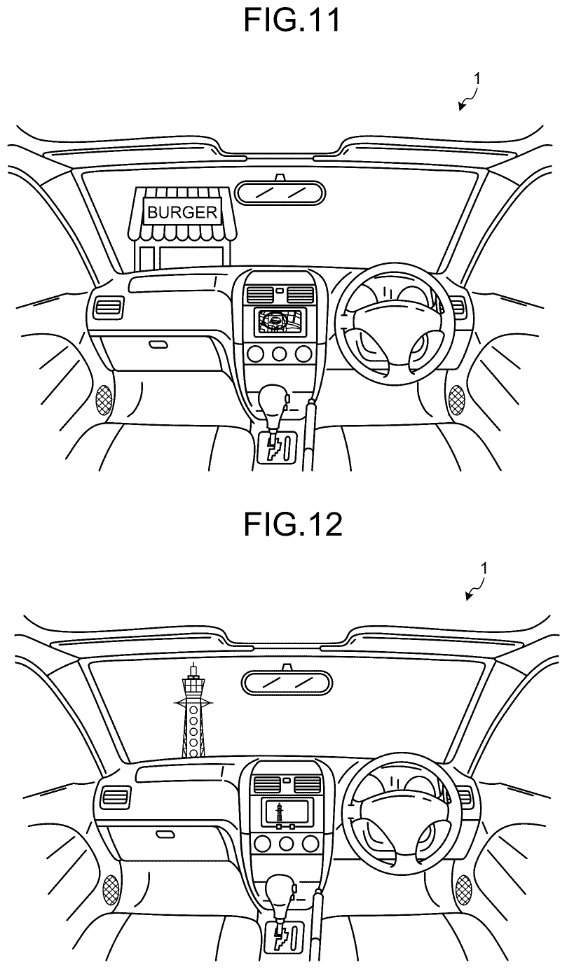

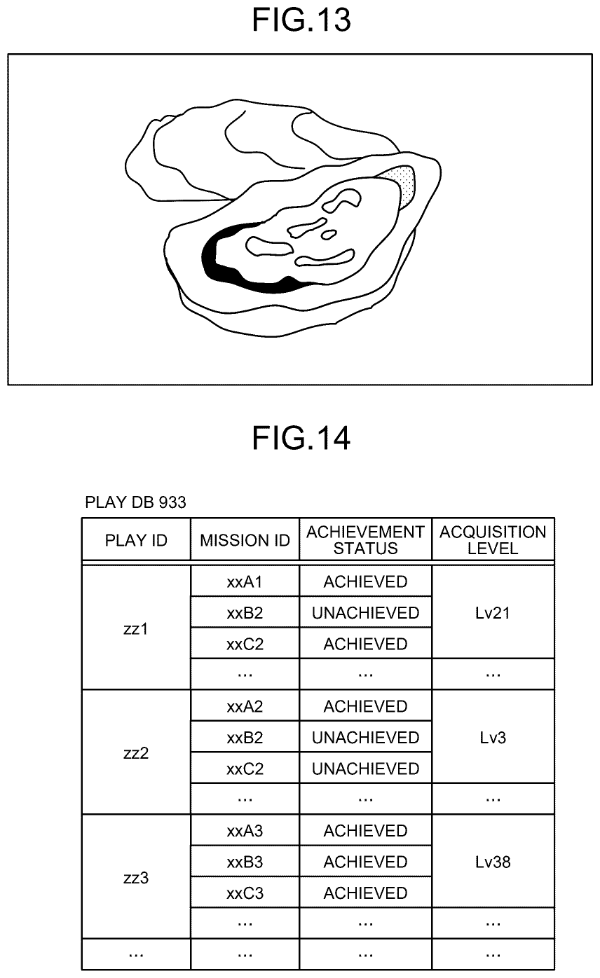

FIGS. 6 to 13 are diagrams schematically illustrating examples of mission contents. FIG. 6 illustrates an example of the type and travel distance of the vehicle 1. In the example of (A) of FIG. 6, traveling of 100 km by a truck is a mission. In the example of (B) of FIG. 6, traveling of 70 km by a bus is a mission. In the example of (C) of FIG. 6, traveling of 30 km by a passenger car is a mission. FIG. 7 illustrates an example of a travel route. In this example, passing through a travel route through xxx intersection is a mission. FIG. 8 illustrates an example of a travel area. In this example, the vehicle 1 entering or passing an area R1 or an area R2 is a mission. FIG. 9 illustrates an example of eco-travel. In this example, performing eco-travel friendly to the global environment, such as reducing exhaust gas by curbing speed change is a mission. FIG. 10 illustrates an example of safe travel. In this example, traveling with more attention to safety than normal travel so as to avoid danger near an intersection is a mission. FIGS. 11 and 12 illustrate examples of building detection. In the example illustrated in FIG. 11, detecting a specific store is a mission. In the example illustrated in FIG. 12, detecting a specific building is a mission. FIG. 13 illustrates an example of article detection. In this example, detecting a certain specialty product is a mission.

Returning to FIG. 3, the play DB 933 is a database in which play in the virtual space VS is registered. This will be described with reference to FIG. 14.

FIG. 14 is a diagram illustrating an example of the play DB 933. The play DB 933 describes a play ID, a mission ID, an achievement status, and an acquisition level in association with each other.

The play ID uniquely identifies the state of play in the virtual space VS and the user U2 who is the player, and is schematically indicated as zz1 or the like.

As described above, the mission ID uniquely identifies the mission. A plurality of missions may be set for one play, and thus a plurality of mission IDs may be associated with one play ID.

The achievement status indicates whether the mission is achieved or not.

The acquisition level is set according to the achievement status. As the play progresses and more missions are achieved, the acquisition level increases. For example, the greater the achievement level of an achieved mission (FIG. 4), the greater the acquisition level. In a case where there are a plurality of achieved missions, the greater the total level of the achievement levels of each mission, the greater the acquisition level. The acquisition level may be equal to the total level.

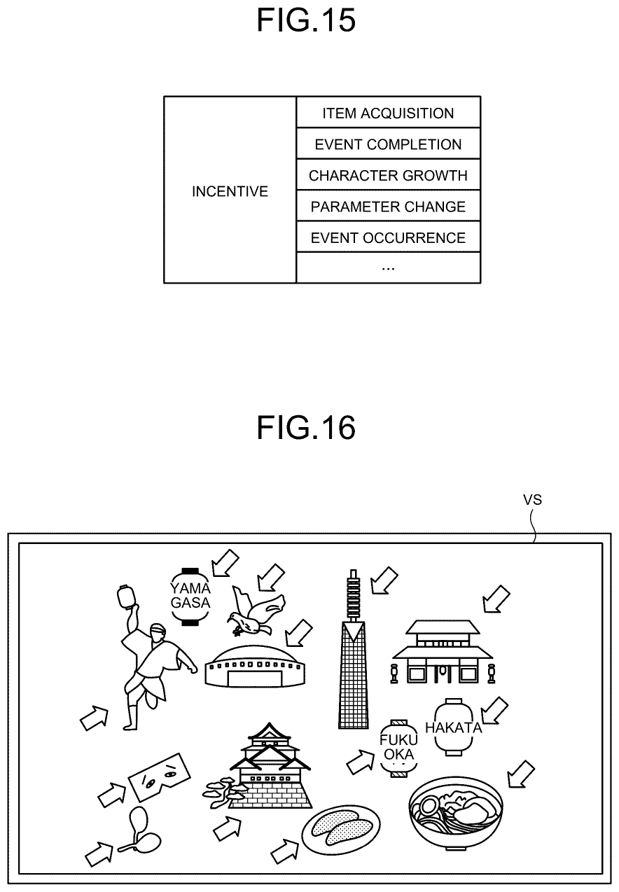

Play of a game or the like in the virtual space VS includes acquisition of an incentive according to achievement of a mission. In that case, the play of the game or the like in the virtual space VS may acquire an incentive corresponding to the acquisition level described above. That is, it means that achievement of a mission by the user U1 in the real space RS is reflected as an incentive to a game or the like played by the user U2 in the virtual space VS. The incentive will be described with reference to FIGS. 15 to 21.

FIG. 15 is a diagram illustrating an example of the incentive. Examples of the incentive include item acquisition, event completion, character growth, parameter change, and event occurrence. Some specific examples will be described with reference to FIGS. 16 to 21.

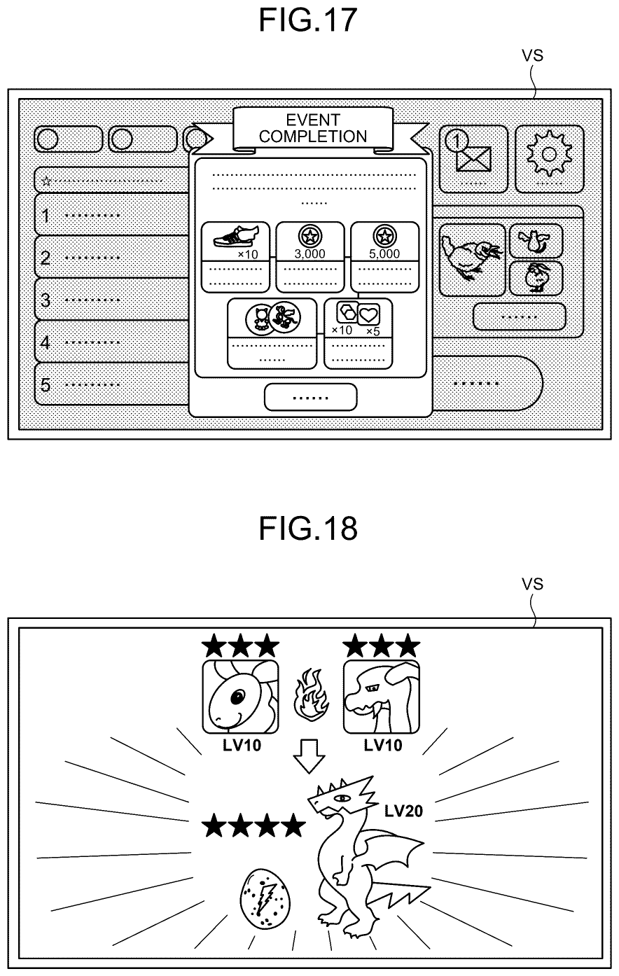

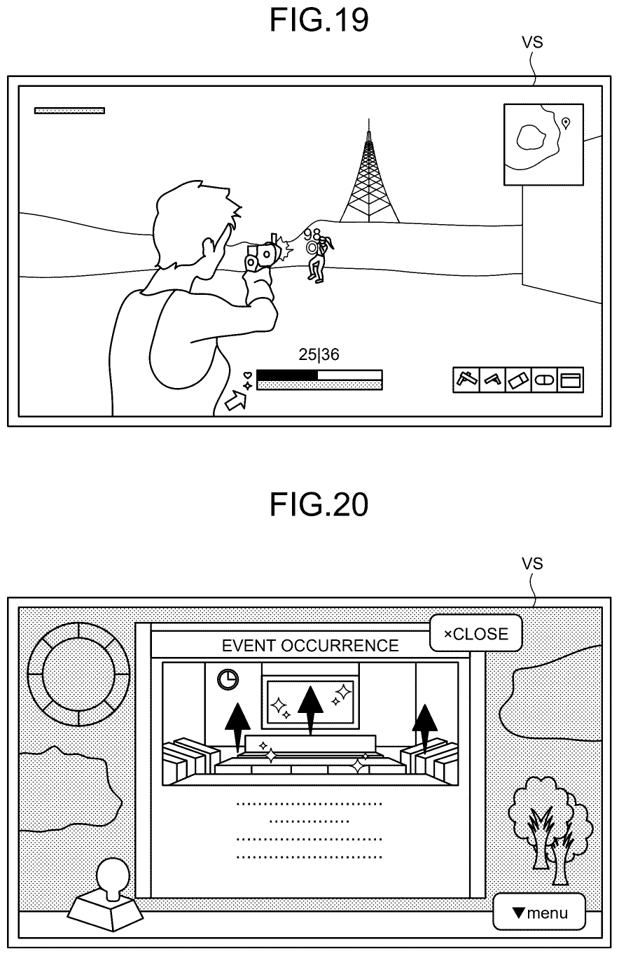

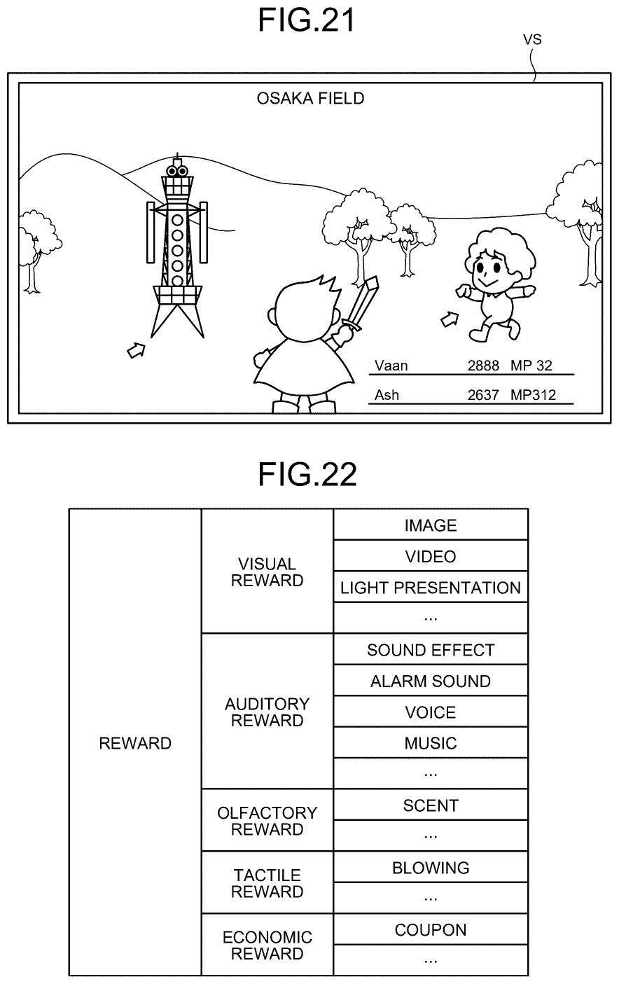

FIGS. 16 to 21 are diagrams schematically illustrating examples of the incentive. In the virtual space VS, various incentives are acquired according to the acquisition level. FIG. 16 illustrates an example of items available in the virtual space VS as indicated by a white arrow. FIG. 17 illustrates an example in which an event in the virtual space VS is completed. FIG. 18 illustrates an example in which a character grows. FIG. 19 illustrates an example in which a parameter such as an ability value in a game is changed as indicated by a white arrow. FIGS. 20 and 21 illustrate examples in which an event occurs. FIG. 21 illustrates an example in which a new character appears as indicated by a white arrow.

In an embodiment, the incentive may be acquired by being converted into a non-fungible token (NFT) on a blockchain (not illustrated). In this case, for example, the items, characters, and the like as described above are distributed as content converted into an NFT.

Returning to FIG. 3, the processing unit 92 of the server device 9 may manage mission and play such that a reward according to the achieved mission or a reward according to the acquired incentive is provided to the user U1 of the vehicle 1. The reward will be described with reference to FIGS. 22 to 27.

FIG. 22 is a diagram illustrating an example of the reward. Examples of the reward include visual reward, auditory reward, olfactory reward, tactile reward, and economic reward. The economic reward is, for example, a coupon, and includes a discount coupon of a store or the like detected for achievement of a mission. Other rewards are presentation and effects that can be experienced by the user 1 with five senses by various devices in the vehicle interior.

Examples of the visual reward include an image, a video, and a light presentation. Examples of the image include a CG image, a photographic image, and an augmented reality (AR) image. Examples of the video include a CG video, a captured video, and an AR video. Examples of the light presentation include presentation by light emission, presentation by illumination, and the like. Examples of the auditory reward include sound effects (including trademark of sound), alarm sound, voice, and music. An example of s the olfactory reward is a scent. Examples of the tactile reward include blowing and vibration.

The reward as described above may be provided using, for example, the HMI 31 of the vehicle control system 11 mounted on the vehicle 1.

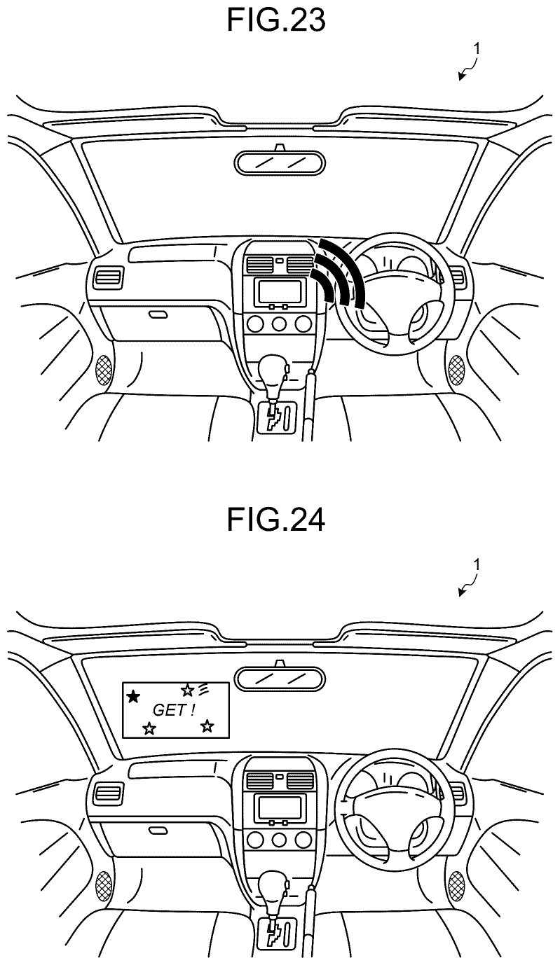

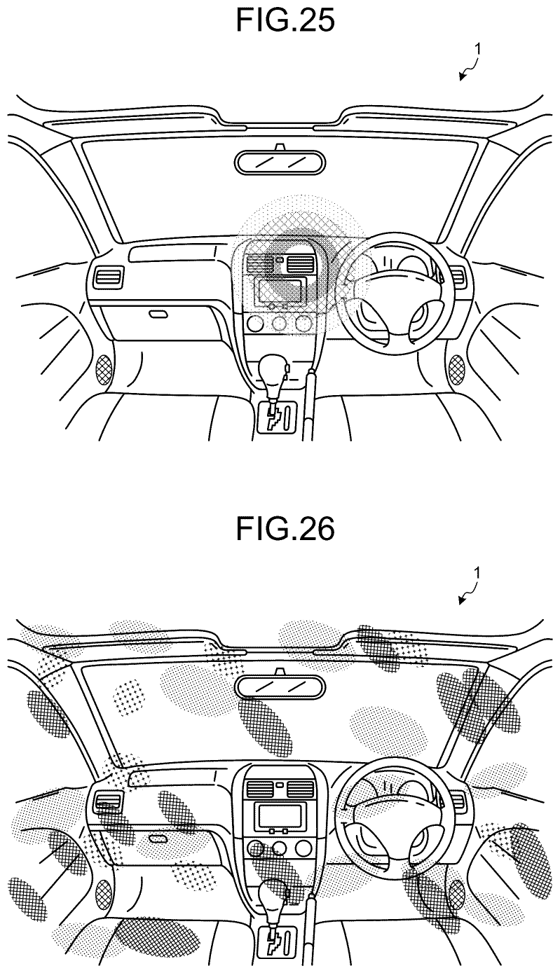

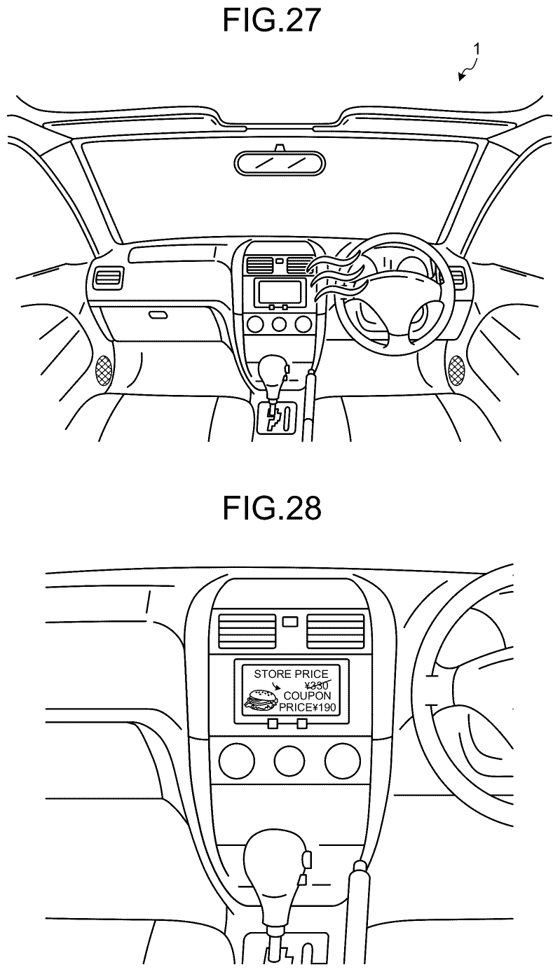

FIGS. 23 to 27 are diagrams schematically illustrating examples of reward provision. FIG. 23 illustrates an example in which a sound effect is output. FIG. 24 illustrates an example in which an AR image is displayed on the windshield of the vehicle 1. FIG. 25 illustrates an example in which a scent is emitted. FIG. 26 illustrates an example in which the inside of the vehicle is irradiated with light in a specific pattern. FIG. 27 illustrates an example in which air blowing is performed. FIG. 28 illustrates an example in which a coupon is issued. Note that one reward does not need to be one element, and in providing one reward, each element may be output by a pattern based on continuous and repetitive rhythmic editing, or a plurality of elements may be output in combination, such as vibrating while being presented with sound and light, without being limited to single light emission, scent generation, vibration, and air blowing.

The visual reward may be displayed in various areas. Some specific examples of the display area of the visual reward will be described with reference to FIGS. 29 to 34.

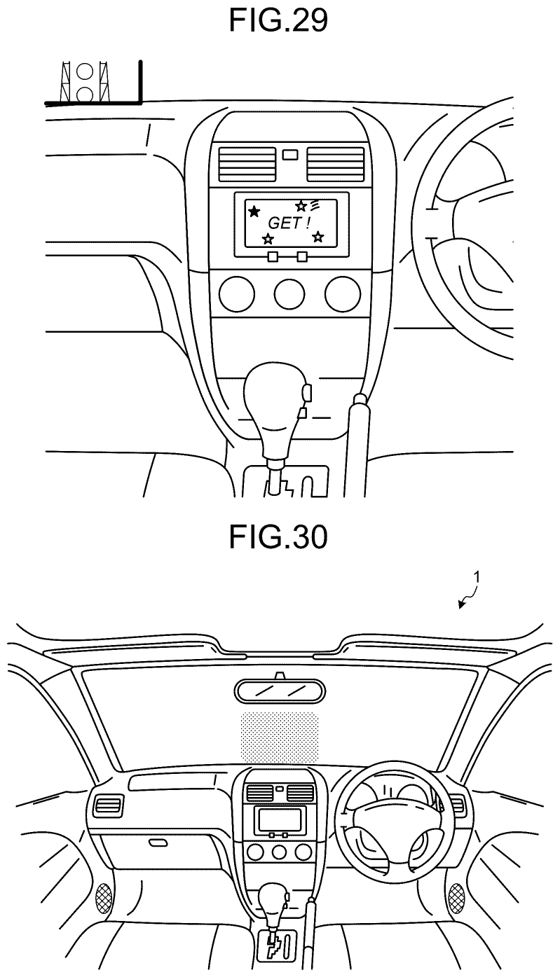

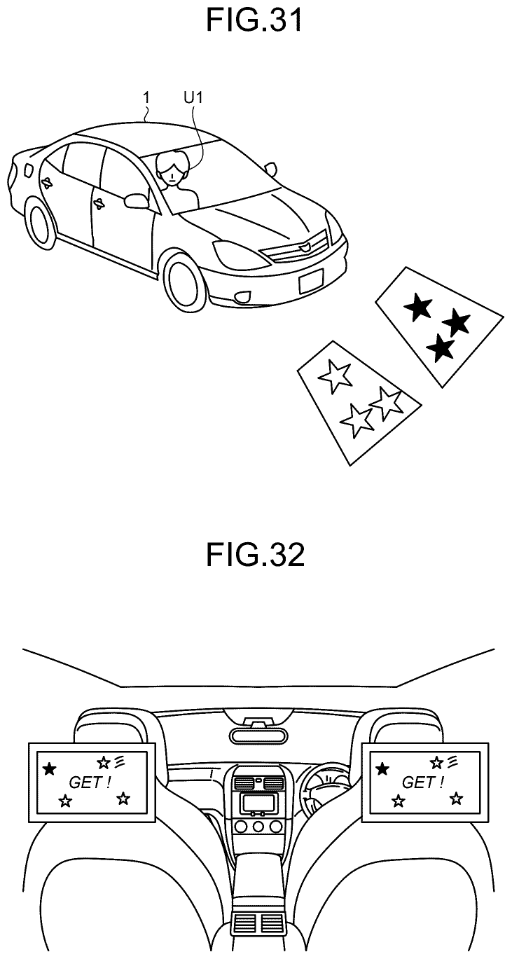

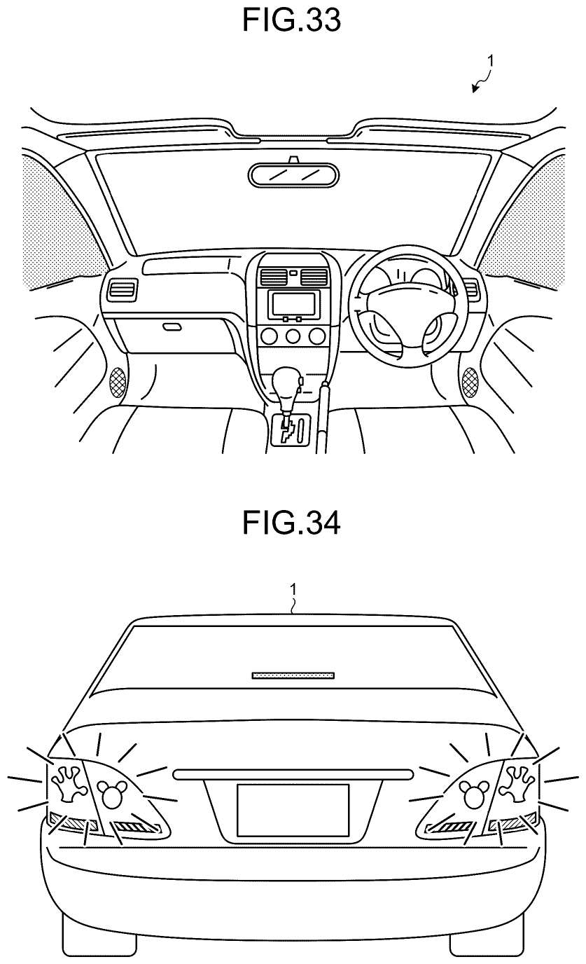

FIGS. 29 to 34 are diagrams schematically illustrating examples of display areas of visual rewards. FIG. 29 illustrates an example in which a navigation operation screen is used as a display area. FIG. 30 illustrates an example in which a head-up display near a windshield as indicated by hatching is used as a display area. FIG. 31 illustrates an example in which the ground, more specifically, the road surface in front of the vehicle 1 is used as a display area. FIG. 32 illustrates an example in which a rear seat monitor in a vehicle is used as a display area. FIG. 33 illustrates an example in which a side window indicated by hatching is used as a display area. FIG. 34 illustrates an example in which a tail lamp of the vehicle 1 is used as a display area. In particular, in a display area such as a head-up display (HUD) or a side window, an AR image may be superimposed on the real space.

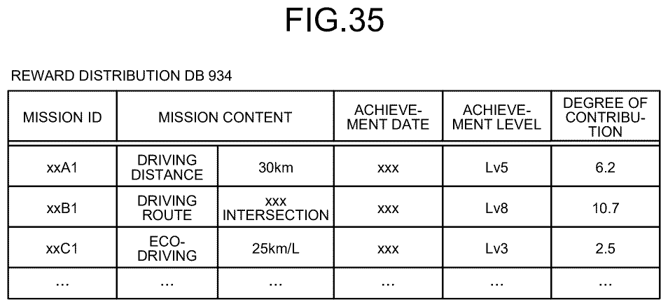

Returning to FIG. 3, as described above, a reward according to the acquired incentive may be provided to the user U1 of the vehicle 1. Here, in a case where one incentive is acquired by achievement of a plurality of missions by different users U1, distribution of the reward to each user U1 becomes a problem. In an embodiment, the processing unit 92 of the server device 9 may manage mission and play such that a reward according to the degree of contribution to the acquisition of the incentive is provided to the user U1 of the vehicle 1. For example, the processing unit 92 generates and updates the reward distribution DB 934 to manage distribution of rewards. The reward distribution DB 934 will be described with reference to FIG. 35.

FIG. 35 is a diagram illustrating an example of the reward distribution DB 934. For example, for each incentive acquired in the play, a table including a plurality of missions contributing to acquisition of the incentive is generated and managed. In this example, the reward distribution DB 934 describes a mission ID, a mission content, an achievement date, an achievement level, and a degree of contribution in association with each other. The mission ID, the mission content, and the achievement level are as described above. The achievement date is a date on which the mission is actually achieved. The degree of contribution corresponds to a degree of contribution to acquisition of an incentive. For example, the greater the level of achievement, the greater the degree of contribution. The ratio of the degree of contribution between missions may be the same as the ratio of the achievement level between the missions.

For example, a reward is provided to the corresponding user U1 via each vehicle 1 used to achieve each mission on the basis of the information of the reward distribution DB 934 as described above.

The processing unit 92 distributes a reward to each user U2 who is an achievement person of each mission according to the degree of contribution of each mission. For example, a reward according to the achievement level of the achieved mission is provided to the user U1 of the vehicle 1 who has achieved the mission. It is particularly useful in a case where the reward is a divisible reward such as an economic reward.

As described above, the incentive may be converted into NFT (incentive converted into NFT is also referred to as “NFT content”). The NFT content acquired by the user U2 can be sold in an NFT market, and the price can be obtained as an economic profit.

For example, in a case where an incentive is acquired by achievement of a plurality of missions, the incentive may be managed as NFT content together with the degree of contribution of each mission by the user U1, and at least a part of the economic benefit obtained by the user U2 by sales of the NFT content as described above may be provided to the user U1. That is, the sale price of the NFT content can be included in the reward to the user U1.

Returning to FIG. 3, a flow of service provision by the information processing system 200 will be described. The user U1 exhibits a mission in the real space RS using the vehicle 1, a smart phone, or the like. For example, a list of missions that may be eligible for bidding is prepared, and the user U1 selects a mission that he/she can achieve from the list. The selected mission is registered in the mission DB 932 (FIG. 4) of the storage unit 93 of the server device 9, and is exhibited at a market place or an auction site.

The user U2 uses the terminal device 2, a smartphone, or the like to win a mission necessary for the play in the virtual space VS of the user U2 to acquire an incentive from the exhibited missions (missions registered in mission DB 932). The play related to the successful bid is registered in the play DB 933 (FIG. 14).

For example, as described above, matching (association) between a mission in the real space RS and play in the virtual space VS is completed. The processing unit 92 appropriately updates the mission DB 932, the play DB 933, and the reward distribution DB 934 according to the progress of the mission in the real space RS and the play in the virtual space VS. According to the update of each DB, an incentive is acquired in the virtual space VS played by the user U2, or a reward is provided to the user U1.

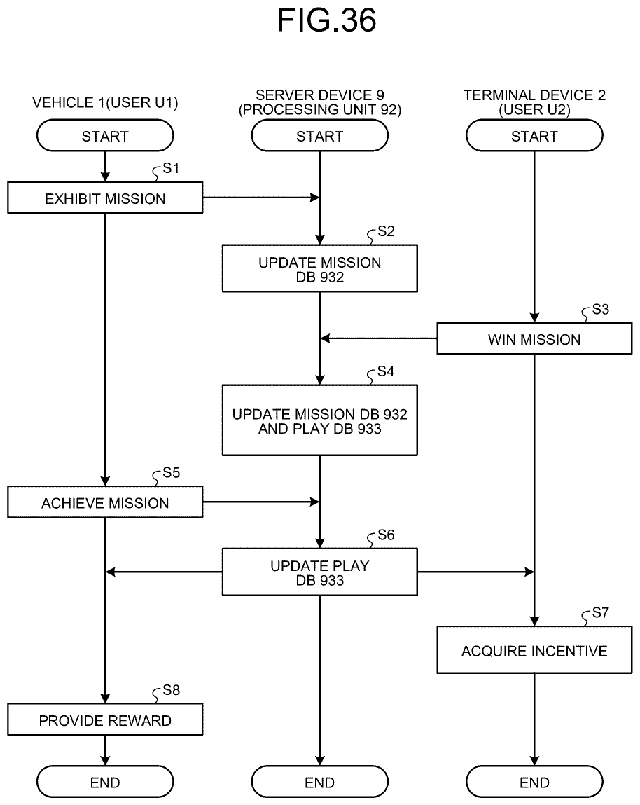

FIG. 36 is a flowchart illustrating an example of processing (information processing method) executed in the information processing system 200. Overlapping descriptions will be omitted as appropriate. For easy understanding, the description will be given assuming that there is one each of the user U1 and the user U2. The mission DB 932, the play DB 933, and the reward distribution DB 934 of the storage unit 93 of the server device 9 are referred to by the vehicle 1 and the terminal device 2 as necessary.

In step S1, the user U1 of the vehicle 1 exhibits a mission. In step S2, the processing unit 92 of the server device 9 updates the mission DB 932 so as to include the exhibited mission. In step S3, the user U2 of the terminal device 2 wins the mission.

In step S4, the processing unit 92 of the server device 9 updates the mission DB 932 and the play DB 933. Specifically, in the mission DB 932, the successful bidder ID of the mission related to matching is updated. The play DB 933 is updated such that the play and the mission related to the matching are described in association with each other. As a result, the mission in the real space RS and the play in the virtual space VS are matched.

In step S5, the user U1 of the vehicle 1 achieves the mission. For example, information indicating that the mission has been achieved is transmitted from the vehicle 1 to the server device 9. Note that detection results of various sensors in the vehicle 1 may be transmitted from the vehicle 1 to the server device 9, and the server device 9 may determine whether or not the mission has been achieved. In this case, information indicating that the mission has been achieved is returned from the server device 9 to the vehicle 1.

In step S6, the processing unit 92 of the server device 9 updates the play DB 933. Specifically, the play DB 933 is updated such that the achievement status of the achieved mission is “achieved” and the acquisition level is increased accordingly. Although not illustrated in FIG. 36, the reward distribution DB 934 may also be updated, for example.

In step S7, the user U2 of the terminal device 2 acquires an incentive. An incentive corresponding to the acquisition level updated in the previous step S6 is acquired.

In step S8, a reward is provided to the user U1 of the vehicle 1. A reward according to the mission achieved in the previous step S5 or the incentive acquired in the previous step S7 is provided to the user U1.

For example, as described above, a new service for associating the real space RS and the virtual space VS is provided.

### 3. Modification

The disclosed technology is not limited to the above embodiment. Some modifications will be described. For example, not only the vehicle 1 but also a mobile terminal may be used for achievement of a mission by the user U1 or provision of a reward to the user U1. Examples of the mobile terminal include a smartphone, a tablet terminal, a notebook PC, and the like, and the mobile terminal can communicate with the server device 9 as in the vehicle 1. The mobile terminal has functions similar to at least some functions of the various sensors and the analysis unit 61(self-position estimation unit 71, recognition unit 73, and the like) of the vehicle control system 11 mounted on the vehicle 1. In addition, the mobile terminal has functions similar to at least some functions of the HMI 31 and the like of the vehicle control system 11 mounted on the vehicle 1. It is possible to achieve missions and provide rewards seamlessly between different devices (vehicle 1 and mobile terminal).

Note that the vehicle 1 often includes more types of and high-performance facilities than a mobile terminal. Therefore, in a case where a mobile terminal is used to achieve a mission, the mobile terminal may be linked with the vehicle 1 by communication or the like, and in particular, a reward excluding an economic reward may be provided via the HMI 31 or the like of the vehicle control system 11 mounted on the vehicle 1.

Some or all of the functions of the server device 9 may be provided in the vehicle 1 or the terminal device 2. In a case where all of the functions of the server device 9 are provided in the vehicle 1 or the terminal device 2, the information processing system 200 need not include the server device 9.

### 4. Example of Hardware Configuration

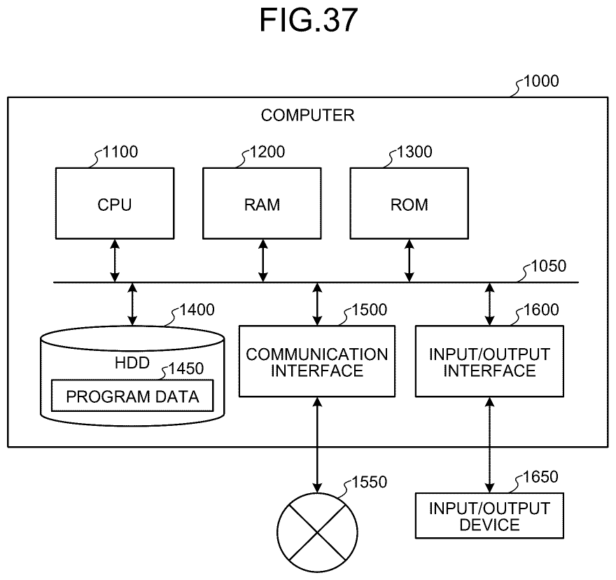

FIG. 37 is a diagram illustrating an example of a hardware configuration of the device. The terminal device 2, the server device 9, and the like described above are implemented by, for example, a computer 1000 as illustrated in FIG. 37.

A computer 1000 includes a CPU 1100, a RAM 1200, a ROM 1300, a storage 1400, a communication interface 1500, and an input/output interface 1600. Each unit of the computer 1000 is connected by a bus 1050.

The CPU 1100 operates on the basis of a program stored in the ROM 1300 or the storage 1400, and controls each unit. For example, the CPU 1100 develops a program stored in the ROM 1300 or the storage 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The storage 1400 is a computer-readable recording medium that non-transiently records a program executed by the CPU 1100, data used by the program, and the like. Specifically, the storage 1400 is a recording medium that records an information processing program (program 2mp or program 931) according to the present disclosure which is an example of program data 1450.

The communication interface 1500 is an interface for the computer 1000 to connect to an external network 1550. For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 can receive data from an input device such as a keyboard and a mouse via the input/output interface 1600. Furthermore, the CPU 1100 can transmit data to an output device such as a display, a speaker, or a printer via the input/output interface 1600. Furthermore, the input/output interface 1600 may function as a media interface that reads a program or the like recorded in a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

In a case where the computer 1000 functions as the server device 9 according to the embodiment of the present disclosure, for example, the communication interface 1500 implements the function of the communication unit 91. The CPU 1100 implements the function of the processing unit 92. The storage 1400 implements the function of the storage unit 93. Note that the CPU 1100 reads the program data 1450 from the storage 1400 and executes the program data, but as another example, the CPU 1100 may acquire these programs from another device via the external network 1550.

### 5. Example Effects

The technology described above is specified as follows, for example. One of the disclosed technologies is the information processing system 200. As described with reference to FIG. 3 and other drawings, the information processing system 200 includes the processing unit 92 that manages a mission in the real space RS achieved using the vehicle 1 and play in the virtual space VS in association with each other. According to the information processing system 200, it is possible to provide a new service that associates the real space RS with the virtual space VS.

As described with reference to FIGS. 4 to 13 and other drawings, the content of the mission may include at least one of travel mode and object detection. The travel mode may include at least one of travel distance, travel route, travel area, eco-travel, and safe travel. The object detection may include at least one of building detection and article detection. For example, such a mission in the real space RS can be associated with play in the virtual space VS.

As described with reference to FIGS. 3 and 14 to 21 and other drawings, the play in the virtual space VS may include acquisition of an incentive according to achievement of a mission in the real space RS. For example, in this manner, the real space RS and the virtual space VS can be associated with each other.

As described with reference to FIGS. 14 to 21 and other drawings, the incentive may include at least one of item acquisition, event completion, character growth, parameter change, and event occurrence. For example, such acquisition of an incentive in the virtual space VS can be associated with a mission in the real space RS.

As described with reference to FIG. 14 and other drawings, the play in the virtual space VS includes acquisition of an incentive according to the acquisition level, and the processing unit 92 may manage the mission in the real space RS and the play in the virtual space VS such that the acquisition level of the corresponding play in the virtual space VS increases when the mission in the real space RS is achieved. For example, the processing unit 92 may manage the mission in the real space RS and the play in the virtual space VS such that the greater the total level of the achievement levels of a plurality of achieved missions in the real space RS, the greater the acquisition level of the corresponding play in the virtual space VS. For example, in this manner, acquisition of an incentive in the virtual space VS can be associated with a mission in the real space RS.

As described with reference to FIGS. 3 and 22 to 35 and other drawings, the processing unit 92 may manage the mission in the real space RS and the play in the virtual space VS such that a reward according to the degree of contribution to acquisition of an incentive by play in the virtual space VS is provided to the user U1 of the vehicle 1 that has achieved a corresponding mission in the real space RS. For example, an incentive may be acquired by being converted into a non-fungible token (NFT), and the reward may include a sale price of NFT content. For example, in this manner, the real space RS and the virtual space VS can be associated with each other.

The information processing program (such as program 281) described with reference to FIGS. 3, 37, and other drawings is also one of the disclosed technologies. The information processing program causes the computer 1000 to execute processing of managing a mission in the real space RS achieved using the vehicle 1 and play in the virtual space VS in association with each other. Such an information processing program can also provide a new service that associates the real space RS with the virtual space VS.

The information processing method described with reference to FIG. 36 and other drawings is also one of the disclosed technologies. The information processing method includes managing a mission in the real space RS achieved using the vehicle 1 and play in the virtual space VS in association with each other (Steps S2, S4, and S6). Also by such an information processing method, it is possible to provide a new service that associates the real space RS with the virtual space VS.

Note that the effects described in the present disclosure are merely examples and the effects are not limited to the disclosed contents. There may be other effects.

Although the embodiments of the present disclosure have been described above, the technical scope of the present disclosure is not limited to the above-described embodiments, and various modifications can be made without departing from the gist of the present disclosure. In addition, components of different embodiments and modifications may be appropriately combined.

Note that the present technology can also have the following configurations.
(1) An information processing system comprising
   a processing unit that manages a mission in a real space achieved using a vehicle and play in a virtual space in association with each other.
(2) The information processing system according to (1), wherein
   a content of the mission includes at least one of travel mode and object detection.
(3) The information processing system according to (2), wherein
   the travel mode includes at least one of travel distance, travel route, travel area, eco-travel, and safe travel.
(4) The information processing system according to (2) or (3), wherein
   the object detection includes at least one of building detection and article detection.
(5) The information processing system according to any one of (1) to (4), wherein
   the play in the virtual space includes acquisition of an incentive according to achievement of the mission in the real space.
(6) The information processing system according to (5), wherein
   the incentive includes at least one of item acquisition, event completion, character growth, parameter change, and event occurrence.
(7) The information processing system according to (5) to (6), wherein
   the play in the virtual space includes acquiring an incentive according to an acquisition level, and
   the processing unit manages the mission in the real space and the play in the virtual space such that the acquisition level of a corresponding play in the virtual space increases when the mission in the real space is achieved.
(8) The information processing system according to (7), wherein
   the processing unit manages the mission in the real space and the play in the virtual space such that the greater a total level of achievement levels of a plurality of achieved missions in the real space, the greater the acquisition level of the corresponding play in the virtual space.
(9) The information processing system according to any one of (5) to (8), wherein
   the processing unit manages the mission in the real space and the play in the virtual space such that a reward according to a degree of contribution to acquisition of the incentive by the play in the virtual space is provided to a user of the vehicle that has achieved a corresponding mission in the real space.
(10) The information processing system according to (9), wherein
   the incentive is acquired by being converted into a non-fungible token (NFT), and
   the reward includes a sale price of the incentive converted into the NFT.
(11) An information processing program causing a computer to execute
   processing of managing a mission in a real space achieved using a vehicle and play in a virtual space in association with each other.
(12) An information processing method comprising
   managing a mission in a real space achieved using a vehicle and play in a virtual space in association with each other.

### Reference Signs List

1 VEHICLE
2 TERMINAL DEVICE
2m STORAGE UNIT
2mp PROGRAM (INFORMATION PROCESSING PROGRAM)
9 SERVER DEVICE
11 VEHICLE CONTROL SYSTEM
21 VEHICLE CONTROL ECU
22 COMMUNICATION UNIT
23 MAP INFORMATION ACCUMULATION UNIT
24 POSITION INFORMATION ACQUISITION UNIT
25 OUTSIDE RECOGNITION SENSOR
26 IN-VEHICLE SENSOR
27 VEHICLE SENSOR
28 STORAGE UNIT
281 PROGRAM (INFORMATION PROCESSING PROGRAM)
29 TRAVEL ASSISTANCE AND AUTOMATIC DRIVING CONTROL UNIT
30 DMS
31 HMI
32 VEHICLE CONTROL UNIT
41 COMMUNICATION NETWORK
51 CAMERA
52 RADAR
53 LiDAR
54 ULTRASONIC SENSOR
61 ANALYSIS UNIT
62 ACTION PLANNING UNIT
63 OPERATION CONTROL UNIT
71 SELF-POSITION ESTIMATION UNIT
72 SENSOR FUSION UNIT
73 RECOGNITION UNIT
81 STEERING CONTROL UNIT
82 BRAKE CONTROL UNIT
83 DRIVE CONTROL UNIT
84 BODY SYSTEM CONTROL UNIT
85 LIGHT CONTROL UNIT
86 HORN CONTROL UNIT
91 COMMUNICATION UNIT
92 PROCESSING UNIT
93 STORAGE UNIT
101F SENSING AREA
102F SENSING AREA
103F SENSING AREA
104 SENSING AREA
105 SENSING AREA
101B SENSING AREA
102B SENSING AREA
103B SENSING AREA
102R SENSING AREA
103R SENSING AREA
102L SENSING AREA
103L SENSING AREA
200 INFORMATION PROCESSING SYSTEM
931 PROGRAM (INFORMATION PROCESSING PROGRAM)
932 MISSION DB
933 PLAY DB
934 REWARD DISTRIBUTION DB
1000 COMPUTER
1050 BUS
1100 CPU
1200 RAM
1300 ROM
1400 STORAGE
1450 PROGRAM DATA
1500 COMMUNICATION INTERFACE
1550 EXTERNAL NETWORK
1600 INPUT/OUTPUT INTERFACE
1650 INPUT/OUTPUT DEVICE
RS REAL SPACE
VS VIRTUAL SPACE

What is claimed is:

1. An information processing system comprising
a processing unit that manages a mission in a real space achieved using a vehicle and play in a virtual space in association with each other.

2. The information processing system according to claim 1, wherein
a content of the mission includes at least one of travel mode and object detection.

3. The information processing system according to claim 2, wherein
the travel mode includes at least one of travel distance, travel route, travel area, eco-travel, and safe travel.

4. The information processing system according to claim 2, wherein
the object detection includes at least one of building detection and article detection.

5. The information processing system according to claim 1, wherein
the play in the virtual space includes acquisition of an incentive according to achievement of the mission in the real space.

6. The information processing system according to claim 5, wherein
the incentive includes at least one of item acquisition, event completion, character growth, parameter change, and event occurrence.

7. The information processing system according to claim 5, wherein
the play in the virtual space includes acquiring an incentive according to an acquisition level, and
the processing unit manages the mission in the real space and the play in the virtual space such that the acquisition level of a corresponding play in the virtual space increases when the mission in the real space is achieved.

8. The information processing system according to claim 7, wherein
the processing unit manages the mission in the real space and the play in the virtual space such that the greater a total level of achievement levels of a plurality of achieved missions in the real space, the greater the acquisition level of the corresponding play in the virtual space.

9. The information processing system according to claim 5, wherein
the processing unit manages the mission in the real space and the play in the virtual space such that a reward according to a degree of contribution to acquisition of the incentive by the play in the virtual space is provided to a user of the vehicle that has achieved a corresponding mission in the real space.

10. The information processing system according to claim 9, wherein
the incentive is acquired by being converted into a non-fungible token (NFT), and
the reward includes a sale price of the incentive converted into the NFT.

11. An information processing program causing a computer to execute
processing of managing a mission in a real space achieved using a vehicle and play in a virtual space in association with each other.

12. An information processing method comprising
managing a mission in a real space achieved using a vehicle and play in a virtual space in association with each other.
